(19) United States
(12) Patent Application Publication
(10) Pub. No.: US 2015/0382361 A1
(43) Pub. Date: Dec. 31, 2015

(54) Handling Transmit Blanking in Multi-Carrier High-Speed Uplink Packet Access-Capable Multi-SIM-Multi-Active Modems

(71) Applicant: QUALCOMM Incorporated, San Diego, CA (US)

(72) Inventors: Karthikeyan Sabapathi, Hyderabad (IN); Praveen Peruru, Hyderabad (IN); Narendra Pulicherla, Hyderabad (IN)

(21) Appl. No.: 14/317,830

(22) Filed: Jun. 27, 2014

(51) Int. Cl. H04W 72/08

(52) U.S. Cl. CPC H04W 72/082

(57) ABSTRACT

Various embodiments implemented on a mobile communication device (e.g., a multi-carrier-capable communication device) mitigate the degraded performance experienced by an aggressor subscription performing transmit blanking on an interfering carrier frequency during a coexistence event by leveraging the availability of a non-interfering carrier frequency. In various embodiments, the mobile communication device may signal the aggressor subscription's network to adjust resources granted to the interfering carrier frequency and the non-interfering carrier frequency to improve overall data throughput and/or to reduce the likelihood of reception problems, such as increased retransmission requests from the network and stalls/delays in sending subsequent transport blocks. If no change in resources is signaled by the network, the mobile communication device may reduce a size of transport blocks transmitted on the interfering carrier frequency. The mobile communication device may signal the network to return to normal resource allocations or transmit normal size transport blocks when the coexistence event ends.

### BACKGROUND

Some new designs of mobile communication devices—such as smart phones, tablet computers, and laptop computers—contain two or more Subscriber Identity Module (“SIM”) cards that provide users with access to multiple separate mobile telephony networks. Examples of mobile telephony networks include GSM, TD-SCDMA, CDMA2000, LTE, and WCDMA. Example multi-SIM mobile communication devices include mobile phones, laptop computers, smart phones, and other mobile communication devices that are configured to connect to multiple mobile telephony networks. A mobile communication device that includes a plurality of SIMs and connects to two or more separate mobile telephony networks using two or more separate radio-frequency (“RF”) transceivers is termed a “multi-SIM-multi-active” or “MSMA” communication device. An example MSMA communication device is a “dual-SIM-dual-active” or “DSDA” communication device, which includes two SIM cards/subscriptions associated with two mobile telephony networks.

Because a multi-SIM-multi-active communication device has a plurality of separate RF communication circuits or “RF resources,” each subscription on the multi-SIM-multi-active communication device may use its associated RF resource to communicate with its mobile network at any time. However, in certain band-channel combinations of operation, the simultaneous use of the RF resources may cause one or more RF resources to desensitize or interfere with the ability of the other RF resources to operate normally because of the proximity of the antennas of the RF chains included in the multi-SIM-multi-active communication device.

Generally, receiver desensitization (sometimes referred to as “de-sense”), or degradation of receiver sensitivity, may result from noise interference of a nearby transmitter. For example, when two radios are close together with one transmitting on the uplink—sometimes referred to as the aggressor communication activity (“aggressor”)—and the other receiving on the downlink—sometimes referred to as the victim communication activity (“victim”)—signals from the aggressor's transmitter may be picked up by the victim's receiver or otherwise interfere with reception of a weaker signal (e.g., from a distant base station). As a result, the received signals may become corrupted and difficult or impossible for the victim to decode. Receiver de-sense presents a design and operational challenge for multi-radio devices, such as multi-SIM-multi-active communication devices, due to the necessary proximity of transmitter and receiver.

### SUMMARY

Various embodiments provide methods, devices, and non-transitory processor-readable storage media for reallocating resources granted to a plurality of carrier frequencies of a first subscription in response to determining that a carrier frequency in the plurality of carrier frequencies is or is about to interfere with reception activities of a second subscription.

Some embodiment methods may include sending a report to a network of the first subscription that the interfering carrier frequency has sufficient resources, sending a report to the network that a non-interfering carrier frequency in the plurality of carrier frequencies has insufficient resources, determining whether updated resource grants for the interfering carrier frequency and the non-interfering carrier frequency have been received from the network, and sending transport blocks to the network via the interfering carrier frequency and the non-interfering carrier frequency based on the updated resource grants received from the network in response to determining that the updated resource grants for the interfering carrier frequency and the non-interfering carrier frequency have been received from the network.

Some embodiment methods may include determining whether the reception activities of the second subscription remain at risk of being de-sensed by the interfering carrier frequency and requesting standard resource grants from the network for the plurality of carrier frequencies in response to determining that the reception activities of the second subscription are no longer at risk of being de-sensed by the interfering carrier frequency.

Some embodiment methods may include reducing a size of transport blocks sent via the interfering carrier frequency in response to determining that the updated resource grants for the interfering carrier frequency and the non-interfering carrier frequency have not been received from the network and sending the reduced-size transport blocks via the interfering carrier frequency to the network. In some embodiments, the reduced-size transport blocks sent via the interfering carrier frequency to the network are smaller than transport blocks sent via the non-interfering carrier frequency to the network.

In some embodiments, reducing a size of transport blocks sent via the interfering carrier frequency may include determining a block error rate (BLER) of the interfering carrier frequency, determining whether the BLER of the interfering carrier frequency exceeds a maximum BLER threshold, and reducing the size of the transport blocks sent via the interfering carrier frequency in response to determining that the BLER of the interfering carrier frequency exceeds the maximum BLER threshold.

Some methods may include maintaining the size of the transport blocks sent via the interfering carrier frequency in response to determining that the BLER of the interfering carrier frequency does not exceed the maximum BLER threshold.

Some embodiment methods may include determining whether reducing the size of the transport blocks sent via the interfering carrier frequency is possible in response to determining that the BLER of the interfering carrier frequency exceeds the maximum BLER threshold, and reducing the size of the transport blocks sent via the interfering carrier frequency may include reducing the size of the transport blocks sent via the interfering carrier frequency in response to determining that reducing the size of the transport blocks sent via the interfering carrier frequency is possible.

Some embodiment methods may include maintaining the size of the transport blocks sent via the interfering carrier frequency in response to determining that reducing the size of the transport blocks sent via the interfering carrier frequency is not possible.

Various embodiments may include a mobile communication device configured with processor-executable instructions to perform operations of the methods described above.

Various embodiments may include a mobile communication device having means for performing functions of the operations of the methods described above.

Various embodiments may include non-transitory processor-readable media on which are stored processor-executable instructions configured to cause a processor of a mobile communication device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with various embodiments.

FIG. 2 is a component block diagram of a multi-SIM-multi-active communication device according to various embodiments.

FIG. 3 is a component block diagram illustrating the interaction between components of different transmit/receive chains in a multi-SIM-multi-active communication device according to various embodiments.

FIG. 4 is a communication system block diagram illustrating an example of coexistence interference between an aggressor subscription transmitting via multiple uplink carrier frequencies and a victim subscription performing reception activities on a downlink carrier frequency.

FIGS. 5A-5B are example data tables including information regarding available and interfering carrier frequencies for a plurality of subscriptions operating on a multi-SIM-multi-active communication device according to various embodiments.

FIG. 6 is a signaling and call flow diagram illustrating communications exchanged between a multi-carrier-capable communication device and a server in an aggressor subscription's network according to various embodiments.

FIG. 7 is a process flow diagram illustrating a method for sending reports to a network of a first subscription to adjust resources granted to an interfering carrier frequency and a non-interfering carrier frequency of the first subscription in response to determining that the interfering carrier frequency interferes with the reception activities of a second subscription according to various embodiments.

FIG. 8 is a process flow diagram illustrating a method for reducing the size of transport blocks sent via an interfering carrier frequency of a first subscription in response to determining that a network of the first subscription has not updated resources granted to the interfering carrier frequency according to various embodiments.

FIG. 9 is a process flow diagram illustrating a method for reducing the size of transport blocks sent via an interfering carrier frequency of a first subscription until the block error rate of the interfering carrier frequency satisfies a minimum-block-error-rate threshold according to various embodiments.

FIG. 10 is a component block diagram of a multi-carrier-capable, multi-SIM-multi-active communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “wireless device,” “mobile communication device,” “multi-carrier-capable communication device,” and “multi-SIM-multi-active communication device” are used interchangeably and refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include a programmable processor, memory, and circuitry for connecting to at least two mobile communication networks. The various aspects may be useful in mobile communication devices, such as smart phones, and so such devices are referred to in the descriptions of various embodiments. However, the embodiments may be useful in any electronic devices, such as a DSDA communication device, that may individually maintain a plurality of subscriptions that utilize a plurality of separate RF resources and may utilize multiple carrier frequencies for uplink transmissions (e.g., multi-carrier High-Speed Uplink Packet Access or “HSUPA”).

As used herein, the terms “SIM”, “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” is also be used herein as a shorthand reference to the communication service associated with and enabled by the information stored in a particular SIM as the SIM and the communication network, as well as the services and subscriptions supported by that network, correlate to one another.

As described, one or more subscriptions on a multi-SIM-multi-active communication device may negatively affect the performance of other subscriptions operating on the multi-SIM-multi-active communication device. For example, a dual-SIM-dual-active communication device may suffer from intra-device interference when an aggressor subscription is attempting to transmit while a victim subscription in the dual-SIM-dual-active communication device is simultaneously attempting to receive transmissions. During such a “coexistence event,” the aggressor subscription's transmissions may cause severe impairment to the victim subscription's ability to receive transmissions. This interference may be in the form of blocking interference, harmonics, intermodulation, and other noises and distortion received by the victim subscription. Such interference may significantly degrade the victim's receiver sensitivity, page receptions, and Short Message Service (SMS) reception. These effects may also result in a reduced network capacity of the multi-SIM-multi-active communication device.

Currently, several solutions are implemented on conventional multi-SIM-multi-active communication devices to mitigate victim subscription de-sense. For example, in some solutions, a multi-SIM-multi-active communication device configures the aggressor subscription to reduce or zero its transmit power while the victim subscription is receiving transmissions (sometimes referred to as implementing transmit (“Tx”) blanking) in order to reduce or eliminate the victim subscription's de-sense.

While such current solutions are effective at reducing the victim subscription's de-sense, the improvement to the victim subscription's reception performance is often at the expense of the aggressor subscription's performance. Current solutions that utilize Tx blanking incur a cost on the link-level performance of the aggressor subscription and/or impact the aggressor subscription's uplink throughput because the total amount of data the aggressor subscription is able to send to the network is diminished because some transmissions are lost (i.e., “blanked”) due to low or zeroed transmit power. Specifically, by implementing Tx blanking, some (or all) of the information included in the data blocks sent via the aggressor subscription to the network may be lost, increasing the error rate (e.g., the block error rate or “BLER”) and dropped packets in data streams transmitted to the network of the aggressor subscription.

As a result of the increase in lost data/BLER, the aggressor subscription may experience various problems at the radio-link-control (RLC) level. For example, because Tx blanking sometimes prevents the network from receiving a sufficient amount of data/information to decode some data blocks (e.g., a full sub-frame of data), the network may not send acknowledgements (i.e., “ACKs”) back to the aggressor subscription to signal the aggressor subscription to send the next sequential block of data and/or may request retransmission of missing or unrecoverable data blocks. In response, the mobile communication device may retransmit those data blocks of the aggressor subscription, delaying when the aggressor subscription is able to send the next block of data and generally causing stalls and drops in the aggressor subscription's performance.

In some current designs of multi-SIM-multi-active communication devices, a subscription may communicate with its network on an uplink using two or more carrier frequencies. In some of such “multi-carrier-capable” communication devices, data to be sent to the network is divided among the multiple uplink carrier frequencies. For example, blocks of data may be alternatively sent to the network via a first and a second carrier frequency.

In some instances, a multi-carrier-capable communication device may experience a coexistence event between an aggressor subscription and a victim subscription. Specifically, in such coexistence events, the aggressor subscription may utilize a first carrier frequency that interferes with the victim subscription's reception activities (i.e., an “interfering carrier frequency”) and a second carrier frequency that does not interfere with the victim (i.e., a “non-interfering carrier frequency”).

According to conventional solutions implemented on multi-carrier-capable communication devices, transmissions from the interfering carrier frequency are blanked during the victim subscription's reception activities. For example, during a voice call on a GSM victim subscription, the interfering carrier frequency of a WCDMA aggressor subscription is blanked for each GSM receiving slot. Thus, as a result of implementing Tx blanking on the interfering carrier frequency, the interfering carrier frequency may experience a decreased data throughput and RLC-level problems (e.g., increased retransmission requests, stalls/delays in sending subsequent blocks of data to the network, etc.), thereby decreasing the overall performance of the aggressor subscription, as described.

In overview, various embodiments implemented on a mobile communication device (e.g., a multi-carrier-capable communication device) mitigate the degraded performance (e.g., lower data throughput and RLC-level stalls, delays, retransmissions, etc.) experienced by an aggressor subscription performing Tx blanking on an interfering carrier frequency during a coexistence event by leveraging the availability of a non-interfering carrier frequency. In various embodiments, a processor of the mobile communication device may signal the aggressor subscription's network to adjust resources granted to the interfering carrier frequency and the non-interfering carrier frequency to improve overall data throughput and/or to reduce the likelihood of RLC-level problems, such as increased retransmission requests from the network and stalls/delays in sending subsequent transport blocks.

In various embodiments, the mobile communication device processor may send a report to the aggressor subscription's network indicating that the interfering carrier frequency has sufficient resources (e.g., via a specific signal or bit sometimes referred to herein as a “happy bit” report) to cause the network to decrease the resources granted to the interfering carrier. In some embodiments, the mobile communication device processor may receive an updated resource grant for the interfering carrier frequency that may enable the device processor to send smaller transport blocks via the interfering carrier frequency to the network. Since successfully decoding smaller transport blocks requires comparatively less data to be received by the network, smaller transport blocks are less susceptible to the effects of Tx blanking. As a result, by the mobile communication device sending comparatively smaller transport blocks to the aggressor subscription's network, the network may be able to receive and successfully decode a greater number of such transport blocks, resulting in a lower BLER, fewer retransmission requests from the network, and a reduced risk of experiencing various RLC-level problems, such as window stalls and resets, which may severely degrade data throughput.

In various embodiments, the mobile communication device processor may send a report to the network indicating that the non-interfering carrier frequency has insufficient resources (e.g., via another specific signal sometimes referred to herein as an “unhappy bit” report) to cause the network to increase resources granted to the non-interfering carrier frequency. In such embodiments, the mobile communication device processor may be able to send comparatively larger transport blocks via the non-interfering carrier frequency, enabling the non-interfering carrier frequency to transmit more data (i.e., unblanked data) and, thereby, increasing the aggressor subscription's overall data throughput.

In some embodiments, the network may not respond to the happy-/unhappy-bit reporting as described, in which case the network may not send updated resource grants for the interfering and non-interfering carrier frequencies. In response to determining that the network has not sent such updated resource grants, the mobile communication device processor may reduce the size of the transport blocks sent via the interfering carrier frequency despite not receiving an updated resource grant from the network. Because the network is not responding, the non-interfering carrier frequency's resource grant may not improve, resulting in no overall throughput improvement to the aggressor subscription. However, by sending the reduced-size transport blocks via the interfering carrier frequency, the mobile communication device processor may reduce the likelihood of experiencing various RLC-level problems, such as high block error rates, RLC resets, and/or data stalls, and/or RLC retransmissions. In other words, the mobile communication device may continue sending reduced-size transport blocks via the interfering carrier frequency to increase the likelihood that the network will receive enough of the transport blocks (e.g., a full sub-frame of data) to be able to decode those blocks without needing the aggressor subscription to retransmit lost/blanked data, thereby improving overall data throughput.

In some embodiments, the aggressor subscription's network may determine over time (using known techniques) that the interfering carrier frequency is under-utilizing its resource grants based on the smaller transport block size and/or the happy/unhappy bit reports. For example, the network may implement known methods and techniques to determine that the interfering and/or non-interfering carrier frequencies are not effectively utilizing their resource grants. Thus, in some instances, the network may eventually reduce the interfering carrier frequency's resource grants and increase the non-interfering carrier frequency's resource grants, as described. As a result, the aggressor subscription may experience an overall improved data throughput and reduced risk of RLC-level problems.

In some instances, the aggressor subscription's network may never respond to the happy/unhappy bit reporting and/or to the smaller transport blocks sent via the interfering carrier frequency. To address such cases, in some embodiments the mobile communication device processor may continue sending reduced-size transport blocks via the interfering carrier frequency to mitigate the risk of RLC-level problems.

In some embodiments, the mobile communication device processor may reduce the size of transport blocks sent via the interfering carrier frequency until a block error rate (BLER) associated with the interfering carrier frequency converges to a minimum BLER threshold, which may represent the largest transport blocks that the mobile communication device may send via the interfering carrier frequencies without experiencing unacceptable BLER.

In various embodiments, subscriptions' activities may change during the ordinary course of operating on a mobile communication device, such as when a subscription ceases a transmission cycle and begins a reception cycle or vice versa. Thus, an aggressor subscription at a first time may become a victim subscription at a second time, and the victim subscription at the first time may similarly become an aggressor subscription at a second or third time. Thus, while various embodiments may be described with reference to an aggressor subscription and a victim subscription, the subscriptions may be referred to generally as a first subscription and a second subscription to reflect that the subscriptions' roles as an aggressor communication activity or a victim communication activity may change.

Similarly, for ease of reference, an uplink carrier frequency of a first subscription that interferes with the reception activities of a second subscription may be referred to as the interfering carrier frequency, and another uplink carrier frequency of the first subscription that does not interfere with the reception activities of the second subscription may be referred to as the non-interfering carrier frequency. However, as described with reference to the aggressor and victim subscriptions, an interfering carrier frequency at a first time may be the non-interfering carrier frequency at a second time, and a non-interfering carrier frequency at the first time may be an interfering carrier frequency at some other time. Thus, these references are merely for ease of description and not intended to imply or require a particular carrier frequency to always be either an interfering or a non-interfering carrier frequency.

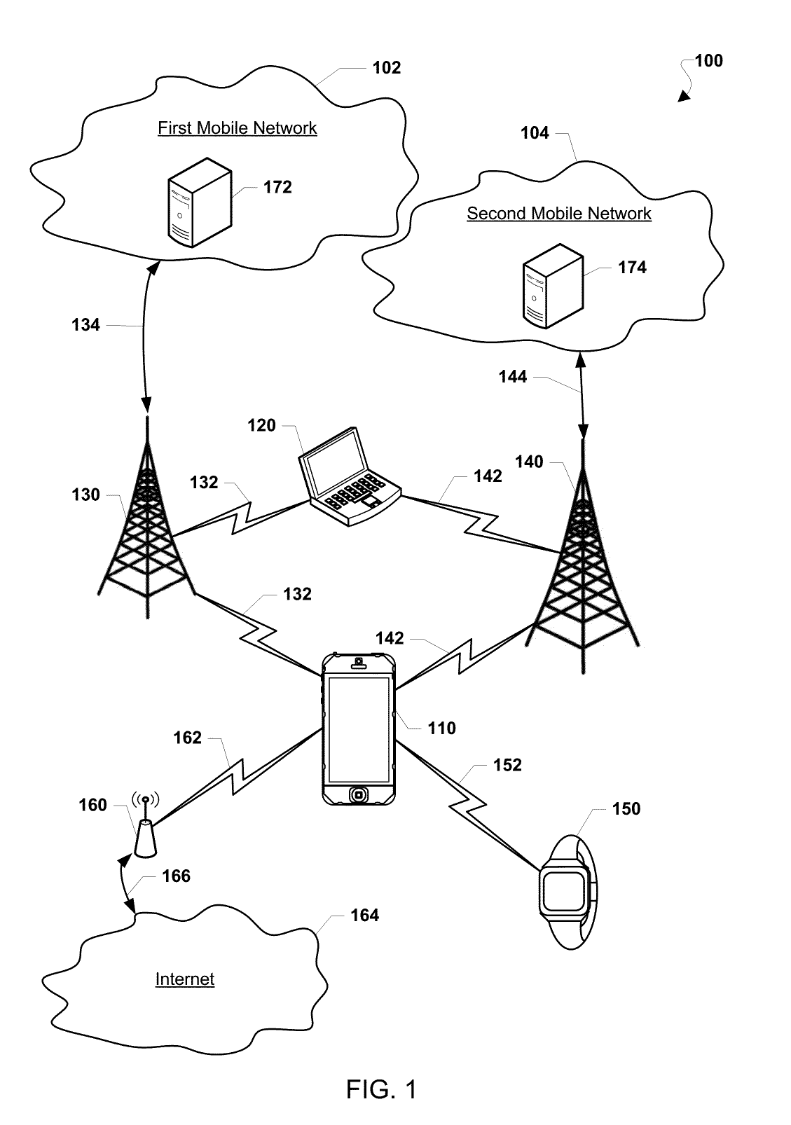

Various embodiments may be implemented within a variety of communication systems 100 that include at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may communicate with the second mobile network 104 through the cellular connection 142 to the second base station 140. The cellular connections 132 and 142 may be made through two-way wireless communication links, such as 4G, 3G, CDMA, TDMA, WCDMA, GSM, and other mobile telephony communication technologies.

While the mobile communication devices 110, 120 are shown connected to the mobile networks 102, 104, in some embodiments (not shown), the mobile communication devices 110, 120 may include one or more subscriptions to two or more mobile networks 102, 104 and may connect to those networks in a manner similar to operations described above.

In some embodiments, the first mobile communication device 110 may establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

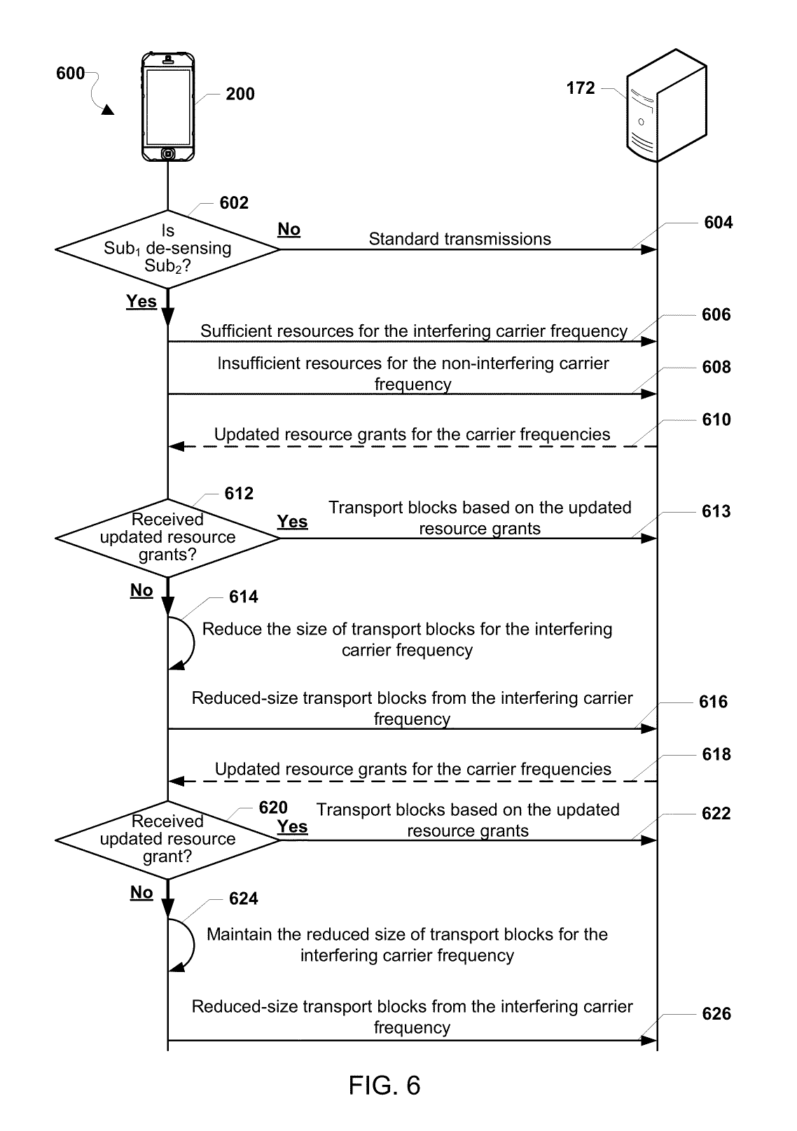

In some embodiments, the first mobile network 102 and the second mobile network 104 may individual include at least one server (e.g., a server 172 and a server 174, respectively) that may be configured to allocate and/or adjust resource grants for multiple uplink carrier frequencies on the mobile communication devices 110, 120 (see, e.g., FIG. 6).

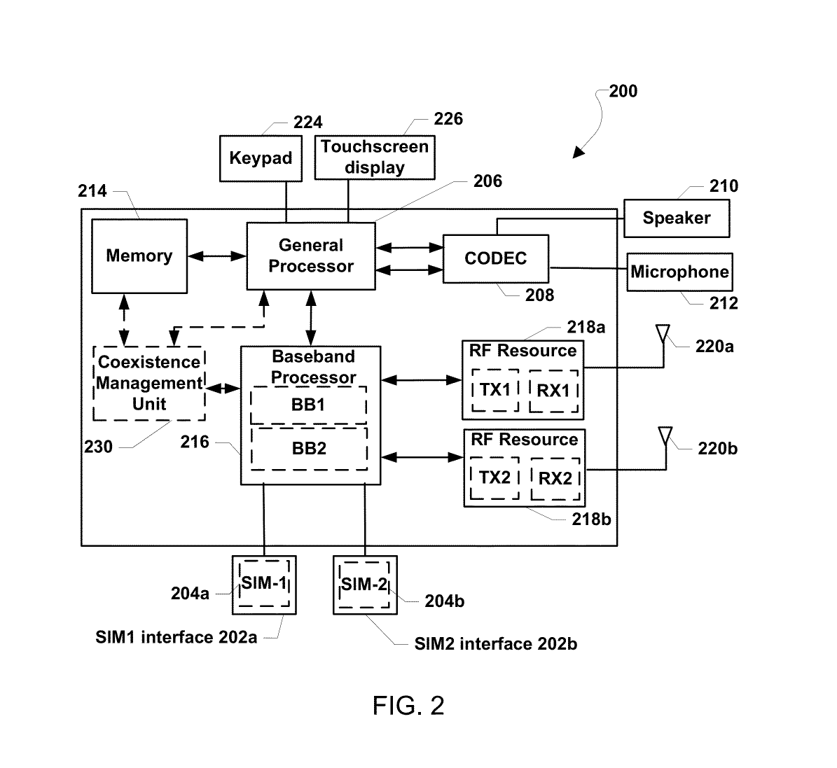

FIG. 2 is a functional block diagram of a mobile communication device 200 suitable for implementing various embodiments. According to various embodiments, the mobile communication device 200 may be similar to one or more of the mobile communication devices 110, 120 as described with reference to FIG. 1. With reference to FIGS. 1-2, the mobile communication device 200 may include a first SIM interface 202a, which may receive a first identity module SIM-1 204a that is associated with a first subscription. The mobile communication device 200 may also include a second SIM interface 202b, which may receive a second identity module SIM-2 204b that is associated with a second subscription.

A SIM in various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the mobile communication device 200 (e.g., memory 214), and thus need not be a separate or removable circuit, chip or card.

The mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

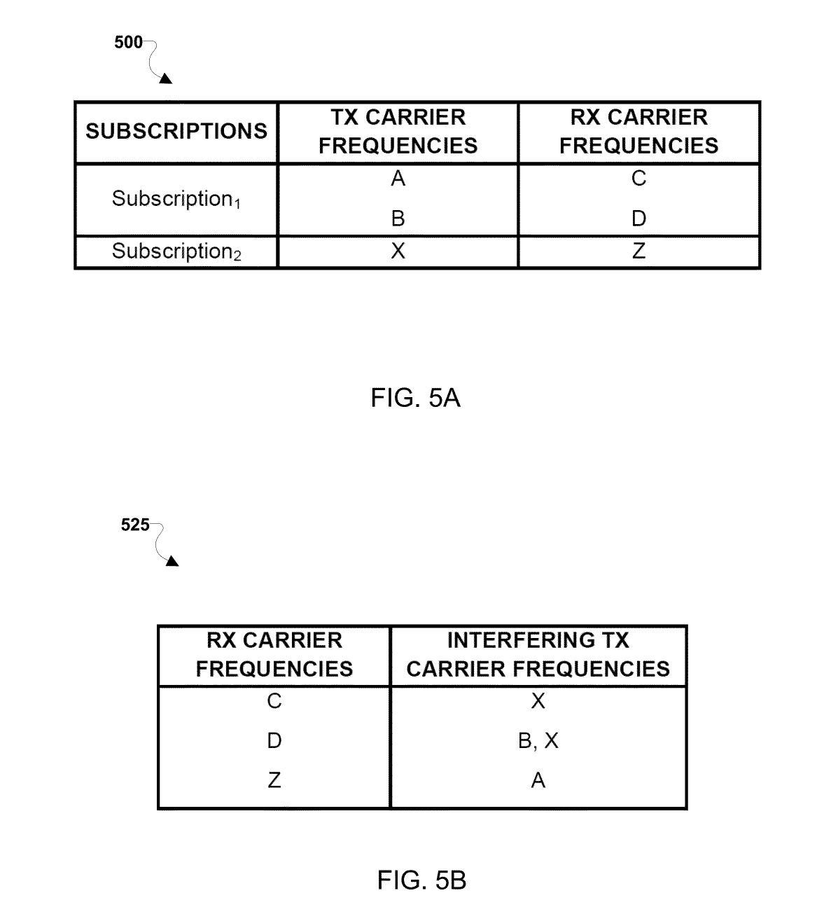

The memory 214 may store an operating system (OS), as well as user application software and executable instructions. The memory 214 may also store application data, such as an array data structure. In some embodiments, the memory 214 may also store one or more look-up tables, lists, or various other data structures that may be referenced to determine whether an uplink carrier frequency of a first subscription interferes with a downlink carrier frequency of a second subscription (see, e.g., FIGS. 5A-5B).

The general processor 206 and the memory 214 may each be coupled to at least one baseband modem processor 216. Each SIM in the mobile communication device 200 (e.g., the SIM-1 204a and the SIM-2 204b) may be associated with a baseband-RF resource chain. The baseband-RF resource chain may include the baseband modem processor 216, which may perform baseband/modem functions for communicating with/controlling a radio access technology (RAT), and may include one or more amplifiers and radios, referred to generally herein as RF resources (e.g., RF resources 218a, 218b). In some embodiments, baseband-RF resource chains may share the baseband modem processor 216 (i.e., a single device that performs baseband/modem functions for all SIMs on the mobile communication device 200). In other embodiments, each baseband-RF resource chain may include physically or logically separate baseband processors (e.g., BB1, BB2).

In some embodiments, the RF resources 218a, 218b may be associated with different SIMs/subscriptions. For example, a first subscription to a WCDMA network may be associated with the RF resource 218a, and a second subscription to a GSM network may be associated with the RF resource 218b. The RF resources 218a, 218b may each be transceivers that perform transmit/receive functions on behalf of their respective subscriptions/SIMs. The RF resources 218a, 218b may also include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general processor 206, the memory 214, the baseband processor(s) 216, and the RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the mobile communication device 200 to enable communication between them, as is known in the art.

Functioning together, the two SIMs 204a, 204b, the baseband modem processor 216, the RF resources 218a, 218b, and the wireless antennas 220a, 220b may constitute two or more RATs. For example, a SIM, baseband processor and RF resource may be configured to support a GSM RAT, an LTE RAT, and/or a WCDMA RAT. More RATs may be supported on the mobile communication device 200 by adding more SIM cards, SIM interfaces, RF resources, and/or antennae for connecting to additional mobile networks.

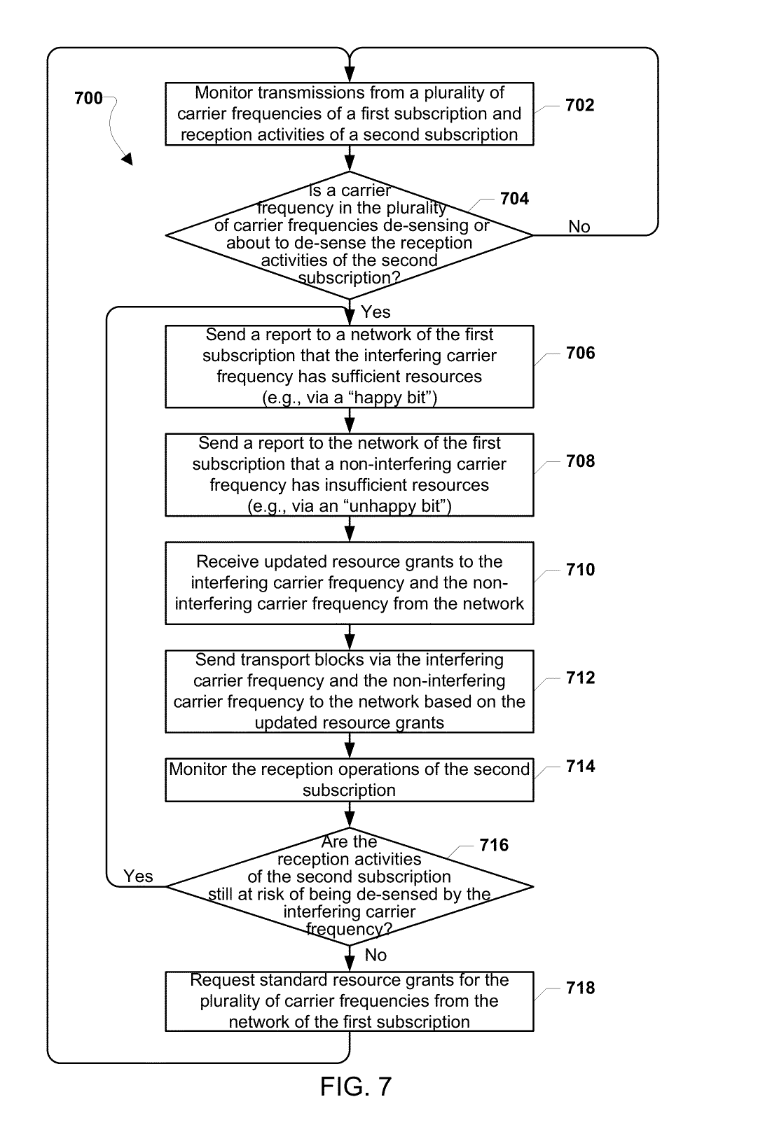

The mobile communication device 200 may include a coexistence management unit 230 configured to manage and/or schedule the subscriptions' utilization of the RF resources 218a, 218b, such as by implementing Tx blanking on transmissions sent via an interfering carrier frequency of a first subscription during reception activities of a second subscription. In some embodiments, the coexistence management unit 230 may be implemented within the general processor 206. In some embodiments, the coexistence management unit 230 may be implemented as a separate hardware component (i.e., separate from the general processor 206). In some embodiments, the coexistence management unit 230 may be implemented as a software application stored within the memory 214 and executed by the general processor 206. In some embodiments, the coexistence management unit 230 may collaborate with a server (e.g., the server 172 or the server 174) in a network of a first subscription to adjust resources granted to the first subscription's interfering carrier frequency and non-interfering carrier frequency, as described (see, e.g., FIGS. 6-7).

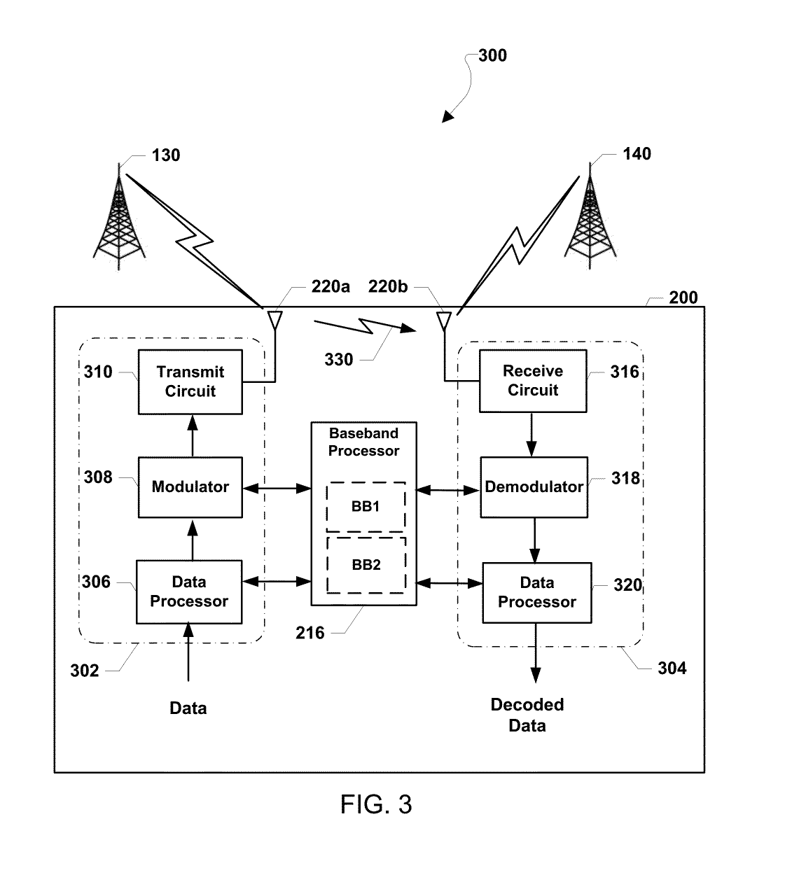

FIG. 3 is a block diagram 300 of transmit and receive components in separate RF resources on the mobile communication device 200 described with reference to FIG. 2, according to various embodiments. With reference to FIGS. 1-3, a transmitter 302 may be part of the RF resource 218a, and a receiver 304 may be part of the RF resource 218b. In some embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted by the transmitter 302 to the first base station 130 via the first wireless antenna 220a, for example.

The second wireless antenna 220b may receive RF modulated signals from the second base station 140 on the second wireless antenna 220b and pass the received signals to the receiver 304. However, the second wireless antenna 220b may also receive some RF signaling 330 from the transmitter 302, which may ultimately compete with the desired signal received from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the mobile communication device 200. Operations of the transmitter 302 and the receiver 304 may be controlled by a processor, such as the baseband modem processor 216.

In various embodiments, each of the transmitter 302 and the receiver 304 may be implemented as circuitry that may be separated from their corresponding receive and transmit circuitries (not shown). Alternatively, the transmitter 302 and the receiver 304 may be respectively combined with corresponding receive circuitry and transmit circuitry, for example, as transceivers associated with the SIM-1 204a and the SIM-2 204b.

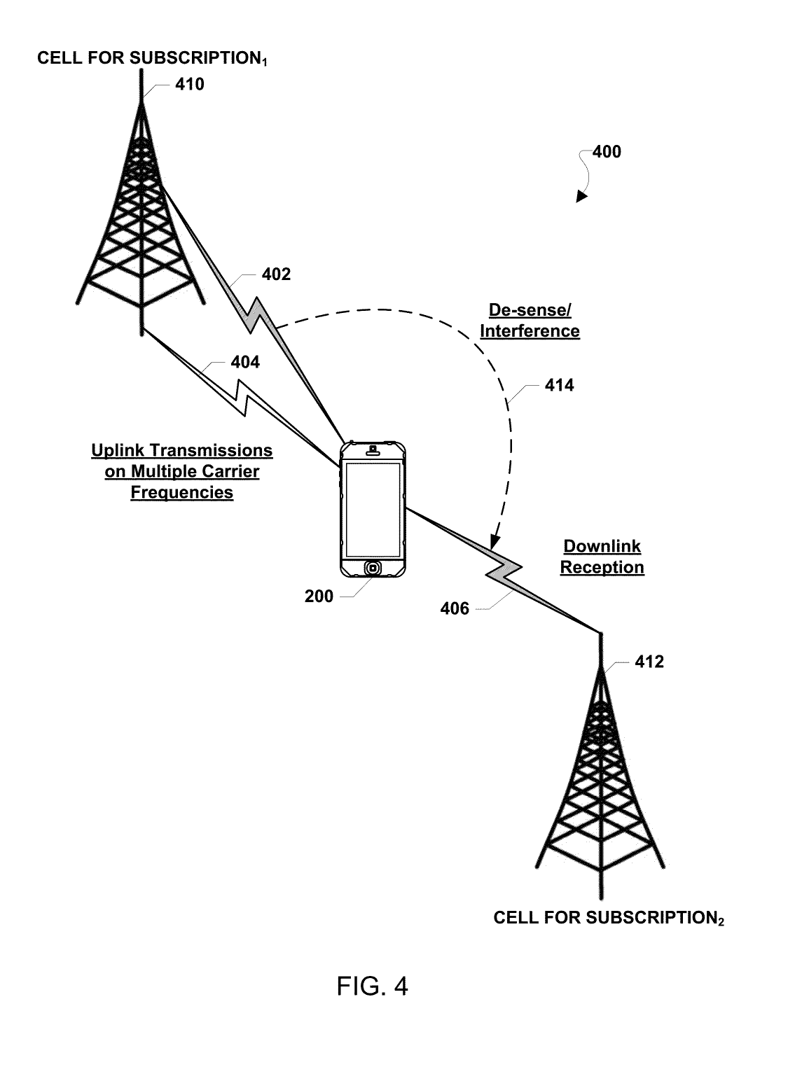

FIG. 4 illustrates a communication system 400 in which a coexistence event occurs on a mobile communication device (e.g., the mobile communication device 200 of FIGS. 2-3) that supports multi-carrier uplink transmissions on a first subscription. With reference to FIGS. 1-4, the mobile communication device 200 may communicate with a cell 410 in the first subscription's network via multiple uplink frequency carriers, such as a first uplink carrier frequency 402 and a second uplink carrier frequency 404. In some embodiments, the mobile communication device 200 may simultaneously support downlink reception activities for a second subscription via a downlink carrier frequency 406.

As described (see FIG. 3), receiver de-sense may occur on the mobile communication device 200 when transmissions sent via an uplink carrier frequency of the first subscription interferes with the ability of a downlink carrier frequency 406 to receive communications from a cell 412 in the second subscription's network. For example, the signals received via the downlink carrier frequency 406 for the second subscription may become corrupted and difficult or impossible to decode as a result of de-sense or interference 414 caused by the first uplink carrier frequency 402. Further, noise from the first uplink carrier frequency 402 may be detected by a power monitor (not shown) that measures the signal strength of surrounding cells for the second subscription, which may cause the mobile communication device 200 to falsely determine the presence of a nearby cell site.

Because coexistence interference between an uplink carrier frequency of a first subscription and a downlink carrier frequency of a second subscription may severely degrade the performance of the second subscription, the mobile communication device 200 may avoid such coexistence interference by determining that there is a likelihood of a coexistence event occurring between an uplink carrier frequency and a downlink carrier frequency and implementing Tx blanking on the uplink carrier frequency in response.

In some embodiments, the mobile communication device 200 may anticipate/predict when a coexistence event will occur between two carrier frequencies by performing a look-up operation in an interference data table stored in memory (e.g., memory 214, memory in the coexistence management unit 230, or the like). FIGS. 5A-5B illustrate example data tables 500, 525 that a mobile communication device (e.g., the mobile communication devices 110, 120, 200 described with reference to FIGS. 1-4) may reference to anticipate/avoid coexistence interference.

With reference to FIGS. 1-5B, the example data table 500 may include a list of the uplink (or “TX”) carrier frequencies and downlink (or “RX”) carrier frequencies available to each of each of two subscriptions operating on the mobile communication device. For example, the data table 500 may indicate that a first subscription (labeled in FIG. 5A as “Subscription₁”) may utilize at least one of uplink carrier frequencies “A” and “B” to send transmissions and at least one of downlink carrier frequencies “C” and “D” to receive communications. For example, the first subscription may be a multi-carrier-capable subscription and thus capable of communicating with its network via a plurality of uplink carrier frequencies. A second subscription (labeled in FIG. 5A as “Subscription”) may be capable of using an uplink carrier frequency “X” to send transmissions and a downlink carrier frequency “Z” to receive transmissions. In some embodiments, the second subscription may be a “single-carrier” subscription and thus capable of utilizing one carrier-frequency to communicate with its network.

In some embodiments, a device processor (e.g., the general processor 206, the baseband modem processor 216, the coexistence management unit 230, a separate controller, and/or the like) may identify the available uplink and downlink carrier frequencies for each subscription based on information regarding available carrier frequency received directly from each of those subscriptions and/or indirectly from those subscriptions' respective networks.

To detect and/or anticipate when such a coexistence event may occur, the device processor may reference a data table, such as the example carrier-frequency-interference data table 525. In some embodiments, the carrier-frequency-interference data table 525 may include information regarding uplink carrier frequencies that interfere with certain downlink carrier frequencies. For example, if downlink carrier frequency “Z” is currently available to the second subscription, the device processor may use the carrier-frequency-interference data table 525 to determine that uplink carrier frequency “A” will interfere with the downlink carrier frequency “Z” of the second subscription but that the uplink carrier frequency “B” will not interfere with the downlink carrier frequency “Z.” Thus, in the event that the first subscription is utilizing the uplink carrier frequencies “A” and “B” while the second subscription is utilizing the downlink carrier frequency “Z,” the device processor may use the carrier-frequency-interference data table 525 to determine that the uplink carrier frequency A is an interfering carrier frequency and that the uplink carrier frequency B is a non-interfering carrier frequency. Based on such a determination, the device processor may implement Tx blanking during transmissions sent via the interfering carrier frequency to avoid the potential for interference between those subscriptions, and may attempt to adjust resources granted to the first subscription's uplink carrier frequencies to improve the first subscription's overall performance (see, e.g., FIGS. 6-9).

In some embodiments, two carrier frequencies may interfere with each other in the event that they are the same, overlap, and/or otherwise have characteristics (e.g., be harmonics or sub-harmonics thereof) known to cause interference with each other. Such interference can be determined in advance by a manufacturer of the mobile communication device, a manufacturer of the modems, network operators, and independent parties (e.g., protocol organization, independent testing labs, etc.). Thus, the carrier-frequency-interference data table 525 may be predefined and loaded in memory of the mobile communication device, within one or more of the SIMs, or within a modem within the device. In some embodiments the mobile communication device may be configured to generate a carrier-frequency-interference data table (e.g., the carrier-frequency-interference data table 525) by recognizing when de-sense is occurring and recording the carrier frequencies in use at the time by each of the subscriptions.

In various embodiments, a data table (e.g., the data tables 500, 525) may be organized according to a variety of data structures or formats, such as an associative list, a database, a linked list, etc. For example, the carrier-frequency-interference data table 525 is a simple data table in which a downlink carrier frequency may be used as a look-up data field to determine the uplink carrier frequencies that will interfere with that downlink carrier frequency.

FIG. 6 is a signaling and call flow diagram 600 illustrating communications exchanged between a multi-carrier-capable communication device (e.g., the mobile communication device 200 of FIGS. 2-4) and a server (e.g., the server 172 of FIG. 1) of a network to adjust resources granted to multiple uplink carrier frequencies of a first subscription on the mobile communication device 200 in response to determining that at least one of the multiple uplink carrier frequencies is de-sensing/interfering with a downlink carrier frequency of the second subscription.

In determination operation 602, a device processor (e.g., the general processor 206 of FIG. 2, the baseband modem processor 216, the coexistence management unit 230, a separate controller, and/or the like) on the mobile communication device 200 may determine whether the first subscription is de-sensing a second subscription, such as by determining that an uplink carrier frequency that the first subscription is using to transmit to its mobile network will de-sense/interfere a downlink carrier frequency of the second subscription. In some embodiments, the device processor may perform a lookup in one or more data tables (e.g., the data tables 500, 525) for the frequency carriers currently used by the first and second subscriptions to make this determination.

In response to determining that the first subscription will not de-sense the second subscription (i.e., determination operation 602=“No”), the device processor may send standard transmissions 604 from the first subscription to the server 172 via the multiple uplink carrier frequencies.

In response to determining that the first subscription will de-sense the second subscription (i.e., determination operation 602=“Yes”), the device processor may send a signal 606 to the server 172 indicating that the interfering carrier frequency (i.e., the carrier frequency interfering with the second subscription's reception activities) has sufficient resources. The device processor may also send a signal 608 to the server 172 that reports that the non-interfering carrier frequency has insufficient resources.

In some embodiments, the signals 606, 608 may prompt the server 172 to adjust the resources that are granted to each of the interfering and non-interfering carrier frequencies. For example, because the signal 606 indicates that the interfering carrier frequency has sufficient resources, the server 172 may reduce the amount of resources granted to the interfering carrier frequency, such as by reducing the required size of the transport blocks sent via the interfering carrier frequency. Similarly, the server 172 may increase the amount of resources granted to the non-interfering carrier frequency in response to receiving the signal 608 reporting that the non-interfering carrier frequency has insufficient resources. In such embodiments, the server 172 may optionally send a signal 610 to the mobile communication device 200 specifying the updated resource grants for the interfering and non-interfering carrier frequencies of the first subscription.

In some instances, the server 172 may not adjust the resource grants for the first subscription's carrier frequencies in response to receiving the signals 606, 608 from the mobile communication device 200. For example, the server 172 may not be configured to recognize the signals 606, 608 as requests for updated resource grants or the server 172 may be experiencing temporary network congestion. In such instances, the device processor may determine whether it has received updated resource grants from the server in determination operation 612.

In response to determining that the mobile communication device 200 has received updated resource grants (i.e., determination operation 612=“Yes”), the device processor may send transmissions 613 of transport blocks via the interfering and non-interfering carrier frequencies based on the updated resource grants received from the server 172. In such circumstances, the transport blocks sent via the interfering carrier frequency may be comparatively smaller (i.e., per the updated resource grant), thereby increasing the likelihood that the first subscription's network may receive and successfully decode those reduced-size transport blocks and potentially avoiding RLC-level problems (e.g., retransmissions, stalls, etc.). Also, the transport blocks sent via the non-interfering carrier frequency may be comparatively larger to enable the non-interfering carrier frequency to send more data to compensate for the smaller transport blocks and blanked data of the interfering carrier frequency.

In response to determining that the mobile communication device 200 has not received updated resource grants (i.e., determination operation 612=“No”), the device processor may reduce the size of transport blocks for the interfering carrier frequency in operation 614, and may send transmissions 616 with the reduced-size transport blocks via the interfering carrier frequency.

In some embodiments, even though the server 172 may not have updated the resources granted to the first subscription's uplink carrier frequencies in response to receiving the signals 606, 608 (i.e., determination operation 612=“No”), the device processor may reduce the transport blocks sent via the interfering carrier frequency in an indirect attempt to cause the server 172 to adjust the resources granted to the first subscription's uplink frequency carriers. Specifically, after receiving reduced-size transport blocks via the interfering carrier for a period of time, the server 172 may eventually recognize that the interfering carrier is not using all of its granted resources using known techniques, and, in some cases, may send updated resource grants for the first subscription's carrier frequencies via an optional signal 618.

In determination operation 620, the device processor may determine whether the server 172 has sent updated resource grants for the interfering and non-interfering frequencies carriers, such as via the optional signal 618, in response to sending reduced-size transport blocks to the server 172, as described. In response to determining that the server 172 has sent updated resource grants for the interfering and non-interfering carrier frequencies (i.e., determination operation 620=“Yes”), the device processor may send transmissions 622 including transport blocks based on the updated resource grants via the interfering and non-interfering carrier frequencies to the server 172. For example, the transport blocks sent via the interfering carrier frequency may be comparatively smaller than the transport blocks sent via the non-interfering carrier frequency.

In response to determining that the server 172 did not send updated resource grants for the carrier frequencies (i.e., determination operation 620=“No”), the device processor may maintain the reduced size of the transport blocks sent via the interfering carrier frequency in operation 624. The device processor may continue sending transmissions 626 to the server 172 that include reduced-size transport blocks via the interfering carrier frequency. In some embodiments, even though the non-interfering carrier frequency may not receive an updated resource grant and thus may be unable to provide an improved throughput to offset the interfering carrier frequency's blanked data, the device processor may maintain the reduced-size transport blocks sent via the interfering carrier frequency to reduce the likelihood of experiencing RLC-level problems.

FIG. 7 illustrates a method 700 for attempting to adjust resource grants for a plurality of uplink carrier frequencies of a first subscription in the event that at least one of the plurality of uplink carrier frequencies de-sense/interferes with the reception activities of a second subscription according to some embodiments. The method 700 may be implemented with a processor (e.g., the general processor 206 of FIG. 2, the baseband modem processor 216, the coexistence management unit 230, a separate controller, and/or the like) of a multi-carrier-capable communication device (e.g., the mobile communication devices 110, 120, 200 described with reference to FIGS. 1-4 and 6).

As described (see, e.g., FIG. 6), to improve the overall performance of the first subscription during a coexistence event with the second subscription, the device processor may attempt to collaborate with the first subscription's network to adjust the resources granted to the first subscription's carrier frequencies in order to reduce the effects of blanking transmissions sent via the first subscription's interfering carrier frequency. Specifically, the device processor may attempt to improve the resources granted to a non-interfering carrier frequency to compensate for the drop in data throughput caused by blanking the transmissions sent via the interfering carrier frequency, and attempt to reduce the size of the interfering carrier frequency's transport blocks to reduce the likelihood that the first subscription will experience various RLC-level problems (e.g., excessive retransmission requests, data stalls, resets, etc.).

With reference to FIGS. 1-7, the device processor may monitor transmissions from the plurality of carrier frequencies of the first subscription and the reception activities of a second subscription in block 702. In some embodiments, the device processor may begin monitoring transmissions in block 702 in response to determining that the first subscription has initiated a data call and is transmitting with multiple carriers (e.g., multi-carrier HSUPA) and that the second subscription has initiated an active voice call or an originating voice call during the first subscription's transmissions.

In determination block 704, the device processor may determine whether a carrier frequency in the plurality of carrier frequencies will de-sense (i.e., is de-sensing or is about to de-sense) the reception activities of the second subscription. In some embodiments, the device processor may make this determination by identifying each of the plurality of uplink carrier frequencies of the first subscription and downlink carrier frequency/frequencies of the second subscription, and cross reference the first and seconds subscription's carrier frequencies in one or more data tables (e.g., the data tables 500, 525 of FIG. 5) to determine whether one or more of the plurality of uplink carrier frequencies is or will interfere with a downlink carrier frequency of the second subscription.

In response to determining that a carrier frequency in the plurality of carrier frequencies will not de-sense the reception activities of the second subscription (i.e., determination block 704=“No”), the device processor may repeat the operations in block 702 by again monitoring transmissions from the plurality of carrier frequencies of the first subscription and the reception activities of the second subscription, and may continue so long as a carrier frequency of the first subscription will not de-sense the reception activities of the second subscription (i.e., while determination block 704=“No”). In some embodiments (not shown), while there is no risk of de-sense, the device processor may request resource grants for the first subscription's plurality of carrier frequencies in a typical fashion using known techniques/methods, such as by requesting standard resource grants (see, e.g., block 718).

In response to determining that a carrier frequency in the plurality of carrier frequencies will de-sense the reception activities of the second subscription (i.e., determination block 704=“Yes”), the device processor may send a report to the network of the first subscription that the interfering carrier frequency has sufficient resources in block 706. For example, the device processor may send a signal to the network in the form of a “happy bit,” which may indicate to the network that the interfering carrier frequency has sufficient or excess resources that may be reallocated to another carrier frequency, such as the non-interfering carrier frequency.

In block 708, the device processor may send a report to the network of the first subscription that a non-interfering carrier frequency has insufficient resources. In some embodiments, the device processor may send a signal in the form of an “unhappy bit” signal, which may be similar in form to the happy bit signal described with reference to block 706 except that the unhappy bit signal indicates to the network that the non-interfering carrier frequency requires additional resources to achieve adequate performance.

In block 710, the device processor may receive updated resource grants to the interfering carrier frequency and the non-interfering carrier frequency from the network. In some embodiments, the updated resource grants for the interfering and non-interfering carrier frequencies may be related to transmit power, transport block size, etc.

In some embodiments, the updated resource grants received from the network (e.g., server 172) may, in essence, shift resources from the interfering carrier frequency to the non-interfering carrier frequency. Specifically, updated resource grants for the non-interfering carrier frequency may increase the non-interfering carrier frequency's data transmission throughput, such as by increasing the allocated transmit power and/or transport block size associated with the non-interfering carrier frequency, potentially offsetting some (or all) of the lower data throughput of the interfering carrier frequency due to Tx blanking.

In some embodiments, updated resource grants for the interfering carrier frequency may reduce the transmit power of the interfering carrier frequency and/or reduce the size of the transport blocks sent to the first subscription's network. Because some of the data sent via the interfering carrier frequency may be blanked to reduce/prevent interfering with the second subscription's reception activities, adjusting the resource grants to the interfering carrier frequency may not improve the interfering carrier frequency's data throughput. However, by reducing the size of the transport blocks sent via the interfering carrier frequency, less data may need to be sent to the first subscription's network to enable the network to successfully decode the data, thereby decreasing the likelihood that the first subscription will experience RLC-level problems caused (e.g., retransmissions, stalls, etc.). As a result, even though the interfering carrier frequency's transmissions may continue to be blanked, sending smaller transport blocks may increase the likelihood that the first subscription will experience comparatively improved performance.

In block 712, the device processor may send transport blocks via the interfering carrier frequency and the non-interfering caring frequency to the network based on the updated resource grants received in block 710. For example, the device processor may send comparatively smaller transport blocks via the interfering carrier frequency and comparatively larger transport blocks via the non-interfering carrier frequency to compensate for the transmissions sent via the interfering carrier frequency that are blanked.

In block 714, the device processor may monitor the reception operations of the second subscription, such as by monitoring the status of an active voice call or originating voice call handled on the second subscription. In determination block 716, the device processor may determine whether the reception activities of the second subscription are still at risk of being de-sensed by the interfering carrier frequency. In other words, the device processor may determine whether the coexistence event between the first subscription and the second subscription is ongoing. For example, the device processor may determine that the coexistence event is ongoing as long as the first subscription continues to transmit while the second subscription handles a voice call.

In response to determining that the reception activities of the second subscription are still at risk of de-sense from the interfering carrier frequency (i.e., determination block 716=“Yes”), the device processor may repeat the above operations in a loop by sending another report to the network of the first subscription that the interfering carrier frequency still has sufficient resources in block 706 and sending another report that the non-interfering carrier frequency still has insufficient resources in block 708. In some embodiments, by repeatedly sending the network reports for the first subscription and the second subscription, the device processor may maintain the carrier frequencies' adjusted resource grants, such as the non-interfering carrier frequency's relatively higher resource grants.

In some embodiments, the transmission of reports to the network in blocks 706 and 708 may be repeated until network responses (i.e., reallocation of resources/updated resource grants by the network) have resolved the problems impacting the reception activities of the second subscription, at which point the device processor may continue sending transport blocks via the interfering and non-interfering carrier frequencies based on the updated resource grants (e.g., in block 712) and may continue monitor communications (e.g., in block 714) to determine when the problem of de-sense is resolved by one call or the other terminating (i.e., in determination block 716). Thus, in such embodiments, the happy or unhappy bits may be transmitted only until the network responds satisfactorily

In response to determining that the reception activities of the second subscription are no longer at risk of de-sense from the interfering carrier frequency (i.e., determination block 716=“No”), the device processor may request standard resource grants for the plurality of carrier frequencies from the network of the first subscription in block 718, such as by performing known techniques/operations.

The device processor may repeat the operations in method 700 in a loop by again monitoring transmissions from the plurality of carrier frequencies the first subscription and the reception activities of the second subscription in block 702.

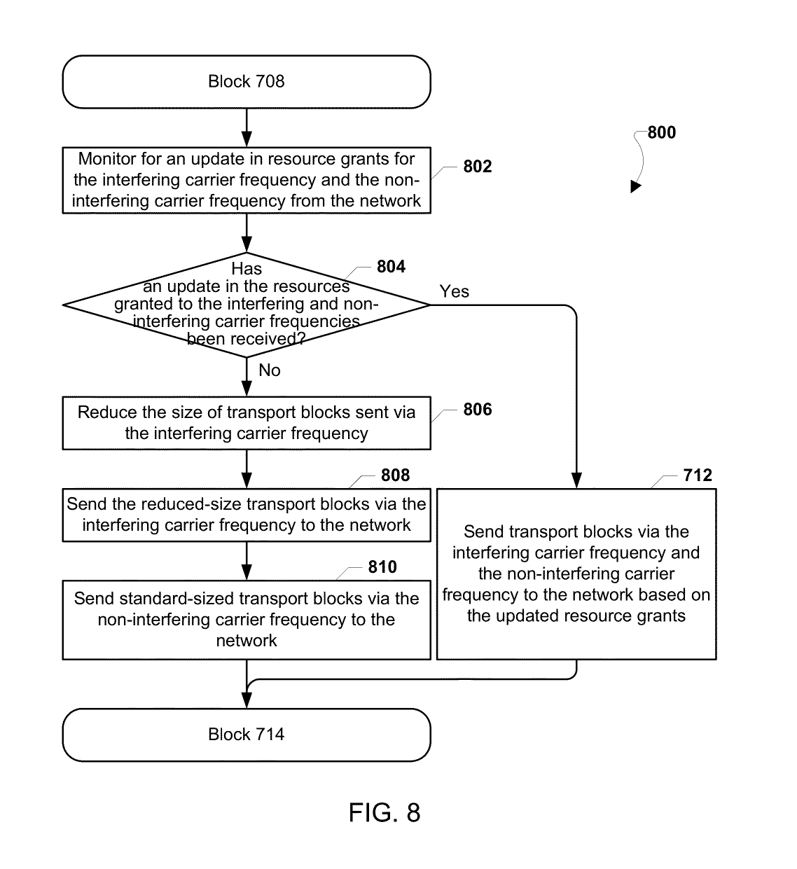

FIG. 8 illustrates a method 800 for reducing the size of transport blocks sent via an interfering carrier frequency in response to determining that there has not been an update in the resources granted to the interfering carrier frequency and the non-interfering carrier frequency according to some embodiments. The method 800 may be implemented with a processor (e.g., the general processor 206 of FIG. 2, the baseband modem processor 216, the coexistence management unit 230, a separate controller, and/or the like) of a multi-carrier-capable communication device (e.g., the mobile communication devices 110, 120, 200 described with reference to FIGS. 1-4 and 6). The operations of the method 800 implement some embodiments of the operations in blocks 710, 712 of the method 700 (FIG. 7). Thus, with reference to FIGS. 1-8, the device processor may begin performing the operations of the method 800 in response to sending a report to the network of the first subscription that a non-interfering carrier frequency has insufficient resources in block 708 of the method 700.

In block 802, the device processor may monitor for an update in resource grants for the interfering carrier frequency and the non-interfering carrier frequency from the network, such as by monitoring for a signal from the network sent in response to the reports sent to the network in blocks 706, 708 of the method 700.

In determination block 804, the device processor may determine whether there has been an update in the resources granted to the interfering and non-interfering carrier frequencies received from the network. In some instances and as described (see FIG. 6), the network may not always recognize or honor the reports from the mobile communication device indicating that the interfering carrier frequency has sufficient resources and that the non-interfering carrier frequency has insufficient resources. For example, the network may be temporarily unable to reallocate resources due to network congestion. Thus, in such instances, the device may not receive an updated resource grants for the interfering carrier frequency and/or the non-interfering carrier frequency.

In response to determining that there has been an update in the resources granted to the interfering and non-interfering carrier frequencies (i.e., determination block 804=“Yes”), the device processor may send transport blocks via the interfering carrier frequency and the non-interfering carrier frequency to the network based on the updated resource grants in block 712. In some embodiments of the operations performed in block 712, the device processor may perform operations similar to the operations described with reference to block 712 of the method 700. For example, the device processor may send comparatively smaller transport blocks via the interfering carrier frequency and/or comparatively larger transport blocks via the non-interfering carrier frequency, according to the updated resource grants received from the network.

In response to determining that there has not been an update in the resources granted to the interfering and non-interfering carrier frequencies (i.e., determination block 804=“No”), the device processor may reduce the size of transport blocks sent via the interfering carrier frequency in block 806. If it does not receive updated resource grants for the non-interfering carrier frequency, the device processor may be unable to improve the non-interfering carrier frequency's data throughput and thus may be unable to compensate for the interfering carrier frequency's reduced data throughput caused by Tx blanking. However, in some embodiments, even though the device processor has not received updated resource grants, the device processor may on its own initiative reduce the size of the transport blocks sent via the interfering carrier frequency to increase the likelihood that the first subscription's network will receive and successfully decode the interfering carrier frequency's transport blocks. In other words, while the device processor may be unable to avoid an overall lowered data throughput, the device processor may decrease the likelihood that the first subscription will experience RLC-level problems with its network (e.g., a reduced BLER).

In block 808, the device processor may send the reduced-size transport blocks via the interfering carrier frequency to the network. The device processor may send standard size transport blocks over non-interfering carrier frequency to the network in block 810.

In some embodiments, the device processor may continue sending reduced-size transport blocks via the interfering carrier frequency and may continually send “happy bit”/“unhappy bit” reports to the first subscriptions network so long as the reception activities of the second subscription are still at risk of being de-sensed by the interfering carrier frequency (see FIG. 7). In some embodiment, the device processor may send the “happy bit”/“unhappy bit” reports only until the network responds with updated resource grants.

In some embodiments, the first subscription's network may eventually recognize the reported underutilization of the interfering carrier frequency's resources (and/or the reported overutilization of the non-interfering carrier frequency's resources) as a result of performing typical/conventional operations. Specifically, components in the network (e.g., counters, timers, etc.), may recognize that the interfering and/or non-interfering carrier frequencies are not using their resource grants effectively, and in response send updated resource grants for those carrier frequencies. For example, the network may send reduced resource grants for the interfering carrier frequency and augmented resource grants for the non-interfering carrier frequency.

After sending standard size transport blocks in block 810 or sending transport blocks based on the updated resource grants in block 712, the device processor may continue performing operations in block 714 of the method 700 by monitoring the reception operations of the second subscription as described.

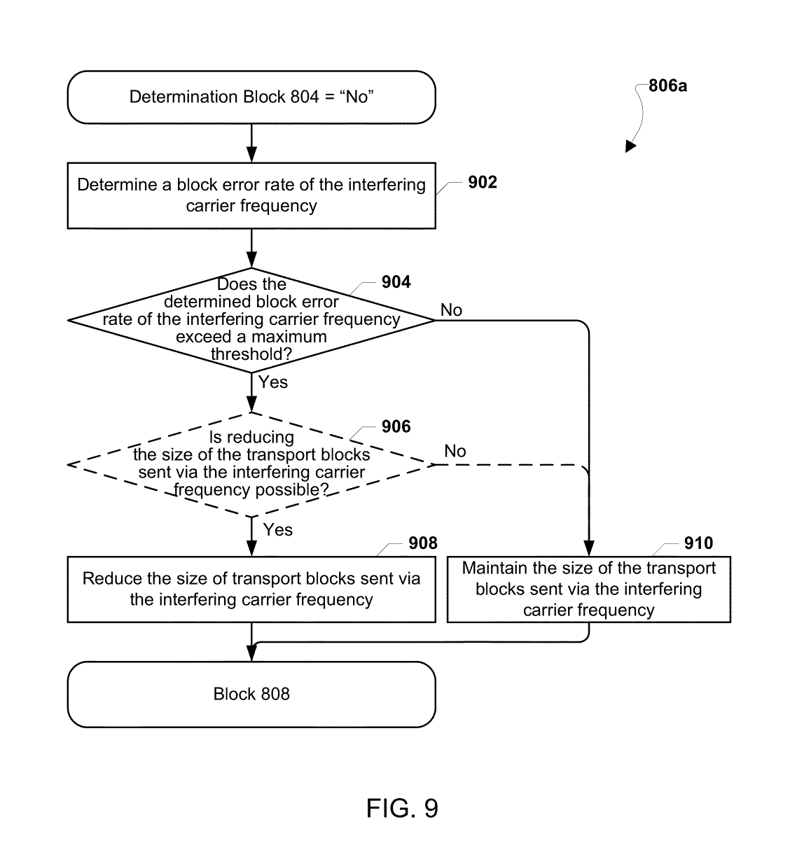

FIG. 9 illustrates a method 806a for reducing the size of transport blocks sent via an interfering carrier frequency until the block error rate of the interfering carrier frequency does not exceed a maximum threshold according to some embodiments. The method 806a may be implemented with a processor (e.g., the general processor 206 of FIG. 2, the baseband modem processor 216, the coexistence management unit 230, a separate controller, and/or the like) of a multi-carrier-capable communication device (e.g., the mobile communication devices 110, 120, 200 described with reference to FIGS. 1-4 and 6). The operations of the method 806a implement some embodiments of the operations in block 806 of the method 800 (FIG. 8). Thus, with reference to FIGS. 1-9, the device processor may begin performing the operations of the method 806a in response to determining that there has not been an update and the resources granted to the interfering and non-interfering carrier frequencies (i.e., determination block 804=“No” in the method 800).

In block 902, the device processor may determine a block error rate (BLER) of the interfering carrier frequency, such as by calculating the number of transport blocks the network has been unable to decode (i.e., erroneous blocks) out of a total number of transport blocks sent to the network within a defined period.

In determination block 904, the device processor may determine whether the BLER determined in block 902 exceeds (e.g., is greater than or equal to) a maximum BLER threshold. In some embodiments, the maximum BLER threshold may correspond with an acceptable block error rate (e.g., 2% BLER) determined according to various known standards.

In some embodiments, the size of the transport blocks sent via the interfering carrier frequency may be associated with the BLER observed on the mobile communication device. Specifically, smaller transport blocks may be more easily received and successfully decoded by the first subscription's network (e.g., as described with reference to FIG. 8), and thus may result in a smaller BLER because there may be fewer erroneous blocks out of the total number of transport blocks sent to the network. As a result, the first subscription may receive fewer retransmission requests, data stalls, etc. In contrast, larger transport blocks may result in a larger BLER as there is a greater risk that a comparatively greater number of the transport blocks sent via the interfering carrier frequency will be partially blanked, thereby preventing the network from successfully decoding those transport blocks.

Thus, in response to determining that the determined BLER of the interfering carrier frequency does not exceed the maximum BLER threshold (i.e., determination block 904=“No”), in other words, the BLER is acceptable, the device processor may maintain the size of the transport blocks sent via the interfering carrier frequency in block 910, as the current size of the transport blocks are being received by the network with an acceptable BLER.

In response to determining that the determined BLER of the interfering carrier frequency exceeds the BLER threshold (i.e., determination block 904=“Yes”), the device processor may optionally determine whether reducing (or further reducing) the size of the transport blocks sent via the interfering carrier frequency is possible, in optional determination block 906. In other words, the device processor may determine whether a reduced-size transport block would include at least a minimum amount of data needed for the network to successfully decode that block.

In response to determining that it is not possible to reduce the size of the transport blocks sent by the interfering carrier frequency (i.e., optional determination block 906=“No”), the device processor may maintain the size of the transport blocks sent via the interfering carrier frequency in block 910, as described. In response to determining that it is possible to reduce the size of the transport blocks sent by the interfering carrier frequency (i.e., optional determination block 906=“Yes”), the device processor may reduce the size of the transport blocks sent via the interfering carrier frequency in block 908.

After reducing the size of the transport blocks sent via the interfering carrier frequency in block 908 or maintaining the size of the transport blocks sent via the interfering carrier frequency in block 910, the device processor may continue performing operations in block 808 of the method 800 by sending the reduced size transport blocks five interfering carrier frequency to the network.

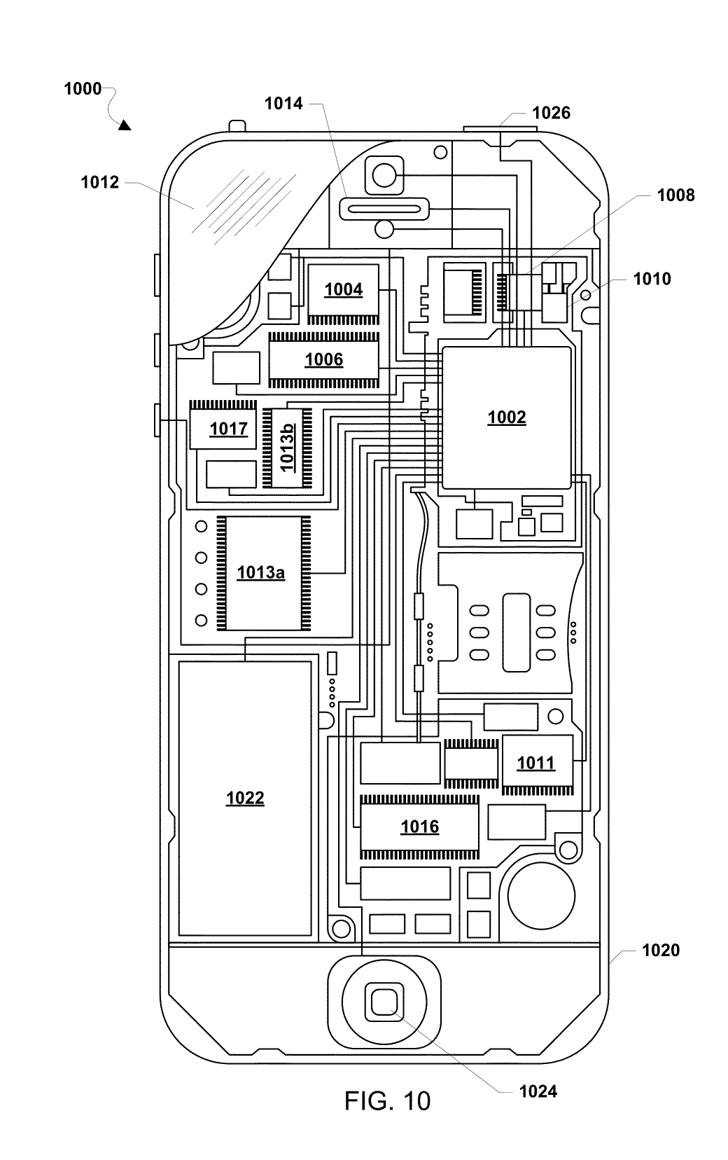

Various embodiments may be implemented in any of a variety of mobile communication devices, an example on which (e.g., mobile communication device 1000) is illustrated in FIG. 10. According to various embodiments, the mobile communication device 1000 may be similar to the mobile communication devices 100, 120, 200 as described above with reference to FIGS. 1-4 and 6. As such, the mobile communication device 1000 may implement the methods 700, 800, 806a in FIGS. 7-9.

Thus, with reference to FIGS. 1-10, the mobile communication device 1000 may include a processor 1002 coupled to a touchscreen controller 1004 and an internal memory 1006. The processor 1002 may be one or more multi-core integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the mobile communication device 1000 need not have touch screen capability.

The mobile communication device 1000 may have one or more cellular network transceivers 1008, 1016 coupled to the processor 1002 and to two or more antennae 1010, 1011 and configured for sending and receiving cellular communications. The transceivers 1008, 1016 and the antennae 1010, 1011 may be used with the above-mentioned circuitry to implement the various embodiment methods. The mobile communication device 1000 may include two or more SIM cards (e.g., SIMs 1013a, 1013b) coupled to the transceivers 1008, 1016 and/or the processor 1002 and configured as described above. The mobile communication device 1000 may include a cellular network wireless modem chip 1017 that enables communication via a cellular network and is coupled to the processor 1002.

The mobile communication device 1000 may also include speakers 1014 for providing audio outputs. The mobile communication device 1000 may also include a housing 1020, constructed of a plastic, metal, or a combination of materials, for containing all or some of the components discussed herein. The mobile communication device 1000 may include a power source 1022 coupled to the processor 1002, such as a disposable or rechargeable battery. The rechargeable battery may also be coupled to the peripheral device connection port to receive a charging current from a source external to the mobile communication device 1000. The mobile communication device 1000 may also include a physical button 1024 for receiving user inputs. The mobile communication device 1000 may also include a power button 1026 for turning the mobile communication device 1000 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method implemented on a mobile communication device for reallocating resources granted to a plurality of carrier frequencies of a first subscription in response to determining that a carrier frequency in the plurality of carrier frequencies is or is about to interfere with reception activities of a second subscription, comprising:
sending a report to a network of the first subscription that the interfering carrier frequency has sufficient resources;
sending a report to the network that a non-interfering carrier frequency in the plurality of carrier frequencies has insufficient resources;
determining whether updated resource grants for the interfering carrier frequency and the non-interfering carrier frequency have been received from the network; and
sending transport blocks to the network via the interfering carrier frequency and the non-interfering carrier frequency based on the updated resource grants received from the network in response to determining that the updated resource grants for the interfering carrier frequency and the non-interfering carrier frequency have been received from the network.

2. The method of claim 1, further comprising:
determining whether the reception activities of the second subscription remain at risk of being de-sensed by the interfering carrier frequency; and
requesting standard resource grants from the network for the plurality of carrier frequencies in response to determining that the reception activities of the second subscription are no longer at risk of being de-sensed by the interfering carrier frequency.

3. The method of claim 1, further comprising:
reducing a size of transport blocks sent via the interfering carrier frequency in response to determining that the updated resource grants for the interfering carrier frequency and the non-interfering carrier frequency have not been received from the network; and
sending the reduced-size transport blocks via the interfering carrier frequency to the network.

4. The method of claim 3, wherein reduced-size transport blocks sent via the interfering carrier frequency to the network are smaller than transport blocks sent via the non-interfering carrier frequency to the network.

5. The method of claim 3, wherein reducing a size of transport blocks sent via the interfering carrier frequency comprises:
determining a block error rate (BLER) of the interfering carrier frequency;
determining whether the BLER of the interfering carrier frequency exceeds a maximum BLER threshold; and
reducing the size of the transport blocks sent via the interfering carrier frequency in response to determining that the BLER of the interfering carrier frequency exceeds the maximum BLER threshold.

6. The method of claim 5, further comprising maintaining the size of the transport blocks sent via the interfering carrier frequency in response to determining that the BLER of the interfering carrier frequency does not exceed the maximum BLER threshold.

7. The method of claim 5, further comprising:
determining whether reducing the size of the transport blocks sent via the interfering carrier frequency is possible in response to determining that the BLER of the interfering carrier frequency exceeds the maximum BLER threshold,
wherein reducing the size of the transport blocks sent via the interfering carrier frequency comprises reducing the size of the transport blocks sent via the interfering carrier frequency in response to determining that reducing the size of the transport blocks sent via the interfering carrier frequency is possible.

8. The method of claim 7, further comprising maintaining the size of the transport blocks sent via the interfering carrier frequency in response to determining that reducing the size of the transport blocks sent via the interfering carrier frequency is not possible.

9. A mobile communication device, comprising:
a plurality of radio-frequency (RF) chains; and
a processor coupled to a plurality of Subscriber Identity Modules (SIMs) and the plurality of RF chains, wherein the processor is configured to:
send a report to a network of a first subscription that an interfering carrier frequency in a plurality of carrier frequencies of the first subscription has sufficient resources, wherein the interfering carrier frequency is a carrier frequency that is or is about to interfere with reception activities of a second subscription;
send a report to the network that a non-interfering carrier frequency in the plurality of carrier frequencies has insufficient resources;
determine whether updated resource grants for the interfering carrier frequency and the non-interfering carrier frequency have been received from the network; and
send transport blocks to the network via the interfering carrier frequency and the non-interfering carrier frequency based on the updated resource grants received from the network in response to determining that the updated resource grants for the interfering carrier frequency and the non-interfering carrier frequency have been received from the network.

10. The mobile communication device of claim 9, wherein the processor is further configured to:
determine whether the reception activities of the second subscription remain at risk of being de-sensed by the interfering carrier frequency; and
request standard resource grants from the network for the plurality of carrier frequencies in response to determining that the reception activities of the second subscription are no longer at risk of being de-sensed by the interfering carrier frequency.

11. The mobile communication device of claim 9, wherein the processor is further configured to:
reduce a size of transport blocks sent via the interfering carrier frequency in response to determining that the updated resource grants for the interfering carrier frequency and the non-interfering carrier frequency have not been received from the network; and
send the reduced-size transport blocks via the interfering carrier frequency to the network.

12. The mobile communication device of claim 11, wherein reduced-size transport blocks sent via the interfering carrier frequency to the network are smaller than transport blocks sent via the non-interfering carrier frequency to the network.

13. The mobile communication device of claim 11, wherein the processor is further configured to:
determine a block error rate (BLER) of the interfering carrier frequency;
determine whether the BLER of the interfering carrier frequency exceeds a maximum BLER threshold; and
reduce the size of the transport blocks sent via the interfering carrier frequency in response to determining that the BLER of the interfering carrier frequency exceeds the maximum BLER threshold.

14. The mobile communication device of claim 13, wherein the processor is further configured to maintain the size of the transport blocks sent via the interfering carrier frequency in response to determining that the BLER of the interfering carrier frequency does not exceed the maximum BLER threshold.

15. The mobile communication device of claim 13, wherein the processor is further configured to:
determine whether reducing the size of the transport blocks sent via the interfering carrier frequency is possible in response to determining that the BLER of the interfering carrier frequency exceeds the maximum BLER threshold; and
reduce the size of the transport blocks sent via the interfering carrier frequency in response to determining that reducing the size of the transport blocks sent via the interfering carrier frequency is possible.

16. The mobile communication device of claim 15, wherein the processor is further configured to maintain the size of the transport blocks sent via the interfering carrier frequency in response to determining that reducing the size of the transport blocks sent via the interfering carrier frequency is not possible.

17. A non-transitory processor-readable storage medium having stored thereon processor-executable instructions configured to cause a processor of a mobile communication device to perform operations for reallocating resources granted to a plurality of carrier frequencies of a first subscription in response to determining that a carrier frequency in the plurality of carrier frequencies is or is about to interfere with reception activities of a second subscription, the operations comprising:
sending a report to a network of the first subscription that the interfering carrier frequency has sufficient resources;
sending a report to the network that a non-interfering carrier frequency in the plurality of carrier frequencies has insufficient resources;
determining whether updated resource grants for the interfering carrier frequency and the non-interfering carrier frequency have been received from the network; and
sending transport blocks to the network via the interfering carrier frequency and the non-interfering carrier frequency based on the updated resource grants received from the network in response to determining that the updated resource grants for the interfering carrier frequency and the non-interfering carrier frequency have been received from the network.

18. The non-transitory processor-readable storage medium of claim 17, wherein the stored processor-executable instructions are configured to cause the mobile communication device processor to perform operations further comprising:
determining whether the reception activities of the second subscription remain at risk of being de-sensed by the interfering carrier frequency; and
requesting standard resource grants from the network for the plurality of carrier frequencies in response to determining that the reception activities of the second subscription are no longer at risk of being de-sensed by the interfering carrier frequency.

19. The non-transitory processor-readable storage medium of claim 17, wherein the stored processor-executable instructions are configured to cause the mobile communication device processor to perform operations further comprising:
reducing a size of transport blocks sent via the interfering carrier frequency in response to determining that the updated resource grants for the interfering carrier frequency and the non-interfering carrier frequency have not been received from the network; and
sending the reduced-size transport blocks via the interfering carrier frequency to the network.

20. The non-transitory processor-readable storage medium of claim 19, wherein reduced-size transport blocks sent via the interfering carrier frequency to the network are smaller than transport blocks sent via the non-interfering carrier frequency to the network.

21. The non-transitory processor-readable storage medium of claim 19, wherein the stored processor-executable instructions are configured to cause the mobile communication device processor to perform operations for reducing a size of transport blocks sent via the interfering carrier frequency, the operations comprising:
determining a block error rate (BLER) of the interfering carrier frequency;
determining whether the BLER of the interfering carrier frequency exceeds a maximum BLER threshold; and
reducing the size of the transport blocks sent via the interfering carrier frequency in response to determining that the BLER of the interfering carrier frequency exceeds the maximum BLER threshold.

22. The non-transitory processor-readable storage medium of claim 21, wherein the stored processor-executable instructions are configured to cause the mobile communication device processor to perform operations further comprising maintaining the size of the transport blocks sent via the interfering carrier frequency in response to determining that the BLER of the interfering carrier frequency does not exceed the maximum BLER threshold.

23. The non-transitory processor-readable storage medium of claim 21, wherein:
the stored processor-executable instructions are configured to cause the mobile communication device processor to perform operations further comprising determining whether reducing the size of the transport blocks sent via the interfering carrier frequency is possible in response to determining that the BLER of the interfering carrier frequency exceeds the maximum BLER threshold; and
the stored processor-executable instructions are configured to cause the mobile communication device processor to perform operations for reducing the size of the transport blocks sent via the interfering carrier frequency, the operations comprising reducing the size of the transport blocks sent via the interfering carrier frequency in response to determining that reducing the size of the transport blocks sent via the interfering carrier frequency is possible.

24. The non-transitory processor-readable storage medium of claim 23, wherein the stored processor-executable instructions are configured to cause the mobile communication device processor to perform operations further comprising maintaining the size of the transport blocks sent via the interfering carrier frequency in response to determining that reducing the size of the transport blocks sent via the interfering carrier frequency is not possible.

25. A mobile communication device, comprising:
means for sending a report to a network of a first subscription that an interfering carrier frequency in a plurality of carrier frequencies of the first subscription has sufficient resources, wherein the interfering carrier frequency is a carrier frequency that is or is about to interfere with reception activities of a second subscription;
means for sending a report to the network that a non-interfering carrier frequency in the plurality of carrier frequencies has insufficient resources;
means for determining whether updated resource grants for the interfering carrier frequency and the non-interfering carrier frequency have been received from the network; and
means for sending transport blocks to the network via the interfering carrier frequency and the non-interfering carrier frequency based on the updated resource grants received from the network in response to determining that the updated resource grants for the interfering carrier frequency and the non-interfering carrier frequency have been received from the network.
